(19) United States
(12) Patent Application Publication
(10) Pub. No.: US 2010/0176738 A1
(43) Pub. Date: Jul. 15, 2010

(54) DEVICE FOR DRIVING A GAS DISCHARGE LAMP

(75) Inventors: Rene Van Honschooten, Eindhoven (NL); Roy Hendrik Anna Maria Van Zundert, Eindhoven (NL); Rob Otte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/602,221

(22) PCT Filed: Jun. 4, 2008
(86) PCT No.: PCT/IB2008/052175

§ 371 Date: Nov. 30, 2009

(30) Foreign Application Priority Data
Jun. 7, 2007 (EP) 07109794.3

(51) Int. Cl. H05B 41/36

(52) U.S. Cl. 315/224

(57) ABSTRACT

A driver (10) for driving a gas discharge lamp (11) comprises at least two controllable switches (M1, M2) and a controller (12) for controlling the switches. The controller has a first operative state in which one switch (M1) is conductive while the other switch (M2) is non-conductive, and has a second operative state in which said other switch (M2) is conductive while said first switch (M1) is non-conductive. The controller comprises a memory device (20) comprising a plurality of memory elements (21) each containing a binary value (“0”; “1”), wherein the value of the last memory element (21(N)) determines the operative state of the controller. Responsive to a clock signal (SQL) generated by a clock device (30), the memory device shifts the contents of each memory element (21(i)) to a subsequent memory element (21(i+1)) and shifts the contents of the last memory element (21(N)) to the first memory element (21(1)).

### FIELD OF THE INVENTION

The present invention relates in general to a method and device for driving a gas discharge lamp, using an alternating lamp current. The present invention relates specifically to the driving of a High Intensity Discharge lamp (HID), i.e. a high-pressure lamp, such as for instance a high-pressure sodium lamp, a high-pressure mercury lamp, a metal-halide lamp. In the following, the invention will be specifically explained for a HID lamp, but application of the invention is not restricted to a HID lamp, as the invention can be more generally applied to other types of gas discharge lamps.

### BACKGROUND OF THE INVENTION

Gas discharge lamps are known in the art, so an elaborate explanation of gas discharge lamps is not needed here. Suffice it to say that a gas discharge lamp comprises two electrodes located in a closed vessel filled with an ionisable gas or vapor. The vessel is typically quartz or a ceramic, specifically polycrystalline alumina (PCA). The electrodes are arranged at a certain distance from each other, and during operation an electric arc is maintained between those electrodes.

An important problem of gas discharge lamps is the possibility of acoustic resonances, i.e. pressure resonances, occurring typically but not exclusively in the range from 9 kHz to 1 MHz, and this problem is particularly serious in the case of HID lamps. As a result of acoustic resonances, the behavior of the arc becomes unpredictable, and possibly unstable; the arc can touch the vessel, damaging the vessel, and the arc can extinguish.

Acoustic resonances involve resonant pressure variations, and an important source of pressure variations are power variations: if the lamp power varies, power dissipation in the arc varies, causing variation in the generated heat and hence in the pressure. Thus, it is desirable to operate the lamp with constant power.

One obvious way of operating a discharge lamp with constant power is DC operation. However, DC operation also involves some disadvantages, including asymmetric erosion of the electrodes and color-segregation. In order to avoid these disadvantages, it is known to operate a discharge lamp with alternating current or with commutating DC current, i.e. a lamp current which has constant magnitude but alternating direction. Such operation inherently involves pressure variations induced by current variations.

Drivers for producing an alternating current may be of the type “Low Frequency Square Wave” or of the resonant type. In the first case, a current source for producing a fixed current is followed by a commutator. The lamp is not part of the resonant circuit, and the commutator is not part of the resonant power conversion. Switching frequencies are typically in the order of about 100 Hz. In the second case, the commutator and the current source are actually integrated, i.e. the commutator forms part of the resonant power conversion. For efficient power conversion, the frequency is typically in the range 100-500 kHz.

In a typical embodiment, a driver for an HID lamp comprises a bridge circuit, for instance a full bridge or half bridge commutation circuit, the bridge circuit having input terminals connected to a power source, and the bridge circuit comprising switches for coupling the lamp to the input terminals. The bridge has two operative states: in a first operative state, the switches are in a state such that a circuit node is connected to one input terminal, whereas in a second operative state, the switches are in a state such that said circuit node is connected to the other input terminal. The bridge's switching from one operative state to another will hereinafter be indicated as “reversing the bridge state”. The driver further comprises a controller for controlling the switches of the bridge circuit. The output frequency of the output control signals from the controller determines the lamp current frequency.

Basically, the controller needs to determine the moments in time when the bridge state is to be reversed. This can be done by calculation in a processor. For accurate timing, the processor needs to operate at a very high frequency, higher than the current frequency. For avoiding acoustic resonance problems, it is known to use current frequencies higher than 1 MHz. Having a processor operate at the required high frequency makes such processor relatively expensive.

When current frequencies higher than 1 MHz are used, design problems occur in relation to circuit components, these problems typically relating to efficiency, size, and costs. With a view to avoiding such design problems, it would be more advantageous if the current frequency would be in the range of 100-500 kHz. However, multiple acoustic resonances typically occur in this range. The exact resonance frequencies may differ from lamp type to lamp type, from individual lamp to individual lamp, and may vary with lamp life and with operation time. Thus, it would be very difficult to find a frequency setting where acoustic frequencies are guaranteed not to occur.

A known method for trying to solve this problem is to modulate the current frequency. By suitably selecting the modulation scheme, the pressure variations induced by current variations are no longer periodic with one specific frequency but they are spread out in a frequency range, while the power contribution at single frequencies is substantially reduced. Even if the current frequency would temporarily coincide with an acoustic resonance frequency, the current frequency will be changed again before the acoustic resonance frequency has had the time to fully develop.

The resulting current frequency spectrum depends on the precise modulation scheme used, as should be clear to a person skilled in the art. It is noted that the present invention does not aim at providing an improved modulation scheme. In order to actually achieve the desired current frequency spectrum, the modulation scheme must be performed as accurately as possible. This again would require a very high operation frequency for a processor. Further, having the modulation scheme performed by a processor would take up much capacity of such processor, and the required circuit would be relatively complicated.

### SUMMARY OF THE INVENTION

An object of the present invention is to overcome or at least reduce the above problems. Specifically, the present invention aims to provide an alternative solution for implementing a modulation scheme. According to the present invention, the controller comprises a non-volatile memory device comprising a plurality of memory elements, each memory element containing one of two possible values, for instance either a 0 or a 1. Each value represents a bridge state. The controller further comprises a control output and a clock input; the clock input is coupled to receive a clock signal from a clock device, the control output provides the control signal for the bridge. This control output always has a value equal to one of the memory elements;

at moments defined by the clock signal, the control output value is made equal to another memory element. Thus, the control output value consecutively takes the values of the memory elements, in a pre-determined which will be indicated as the order of the memory elements. The memory elements may be considered to constitute a shift memory.

Further advantageous elaborations are mentioned in the dependent claims.

An important advantage of the implementation proposed by the present invention is that the clock device and the memory device are independent, “stand alone” devices which function independently from each other. The invention allows for the use of a voltage controlled oscillator, which results in a relatively simple circuit implementation, while further a VCO is specifically designed for accurately producing a clock signal and, in contrast to a processor, a VCO has no further task but to produce a clock signal. A further advantage is that the clock device and the memory device are relatively simple components: if the quasi-random bridge control signal would have to be generated by a processor, this would require much processor capacity and would hence necessitate the use of a large and expensive processor.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating a lamp driver with half-bridge topology;

FIG. 2 is a time diagram schematically showing the lamp current and lamp power as a function of time;

FIG. 3 is a block diagram schematically illustrating a controller for a lamp driver.

### DETAILED DESCRIPTION OF THE INVENTION

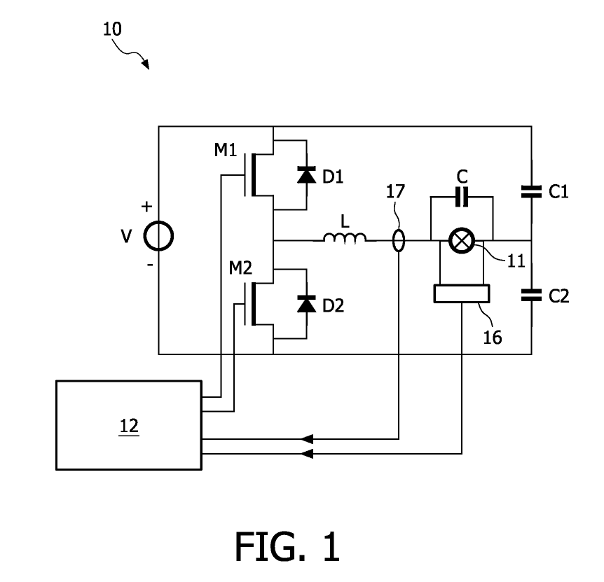

FIG. 1 is a block diagram schematically illustrating a lamp driver 10 with half-bridge topology, for driving a gas discharge lamp 11. Since such half-bridge circuit topology should be known to persons skilled in the art, the design and functioning will be described only briefly. Two switches M1 and M2 are arranged in series, with corresponding diodes D1, D2, between two voltage rails coupled to a source of substantially constant voltage V. The design of this voltage source is not relevant for the present invention. Two capacitors C1 and C2 are also arranged in series between the two voltage rails. The lamp 11 is coupled between on the one hand the junction between the two switches M1 and M2 and on the other hand the junction between the two capacitors C1 and C2, with an inductor L arranged in series with the lamp 11 and a capacitor C arranged in parallel with the lamp 11. The two switches M1 and M2 are controlled alternately by a controller 12, such that they are never closed (i.e. conductive) at the same time. The two capacitors C1 and C2 have relatively high capacitive values, and the switching frequency of the two switches M1 and M2 is relatively high, so that the voltage at the junction between the two capacitors C1 and C2 is virtually constant.

The operation is as follows. The driver 10 has a first switching state in which the upper switch M1 is closed, the lower switch M2 is open (i.e. non-conductive), and the lamp current I (equal to the current through the inductor) is rising. The driver 10 has a second switching state in which the lower switch M2 is closed, the upper switch M1 is open, and the lamp current is decreasing. The circuit is successively in its first and second switching state.

At the moment of transition from the first to the second switching state, the current reaches a maximum value. At the moment of transition from the second to the first switching state, the current reaches a minimum value. Control is conventionally such that the current wave form is symmetrical with respect to zero, i.e. the said minimum current value has the same magnitude as the said maximum value but opposite direction. A full current cycle contains the combination of one first switching state and one second switching state.

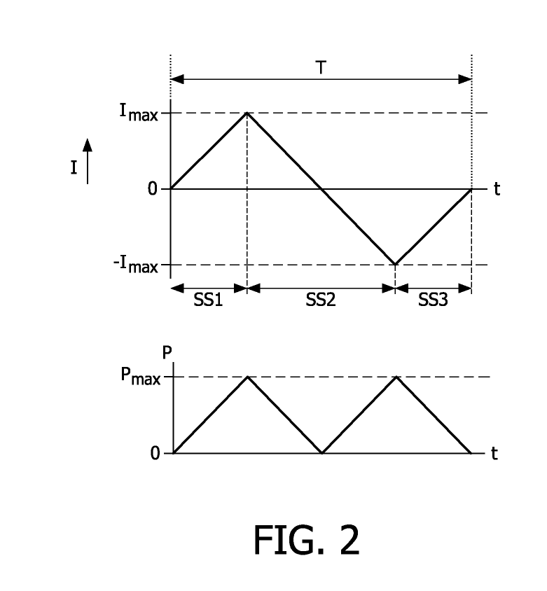

The lamp may be assumed to behave like a voltage source, i.e. the voltage over the lamp is constant during each switching state. Consequently, the voltage over the inductor L is constant during each switching state, so that the current increase during the first switching state SS1 and the current decrease during the second switching state SS2, in a first approximation, are linear with time: the time-derivative dI/dt=constant. This implies that the current waveform is triangular, as illustrated in FIG. 2, which schematically shows lamp current I (upper graph) and corresponding lamp power P (lower graph) as a function of time. The lamp power P also has a triangular waveform, but the frequency is twice the frequency of the current. The current period is indicated as T, which is twice the period of the power.

It is noted that the above description, and the corresponding illustration in FIG. 2, models the current behavior in a somewhat idealistic manner. In reality, the lamp behaves more resistive in the kHz range, but, for illustrative purposes, the triangular waveform will be continued for use in explaining the present invention.

It is noted that alternative circuit designs are possible; for instance, a circuit may have a full bridge topology. Also the operation may be different: the power source may be a current source, and changing the switching state of the bridge may change the current direction. In any case, the switching moments determine the momentary current frequency. Further, the bridge circuit may contain a different resonant topology: instead of being an LC resonator, the bridge circuit may be an LCC, LCL, etc type of circuit. With respect to for instance an LCC circuit, it is noted that such topology may be implemented by choosing capacitor C1 and/or C2 such that it contributes to the resonance.

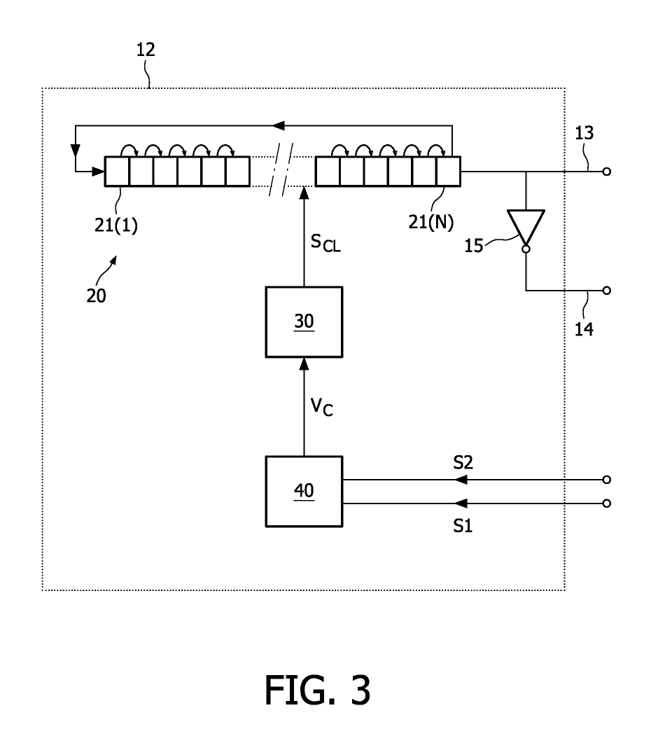

FIG. 3 is a block diagram schematically illustrating details of the controller 12 in accordance with the present invention.

In general, the controller 12 has two output terminals 13, 14 for providing control signals (for instance HIGH/LOW signals) to the switches M1, M2, respectively. The controller 12 has two operative states; in a first operative state, the control signals are such that the first switch is conductive while the second switch is not, and in the second operative state, the control signals are such that the second switch is conductive while the first switch is not. In practice, there will be provided means for preventing that both switches M1, M2 are conductive at the same time, but such means are known per se and are therefore not shown for sake of simplicity.

The controller 12 comprises a non-volatile memory device 20, for instance EEPROM, comprising a plurality of N memory elements 21, individually indicated as 21(1) to 21(N). The memory elements are typically binary elements, either containing value “0” or value “1”. The memory device 20 is responsive to a clock signal S_{CL} from a clock device 30, the clock signal S_{CL} defining regular trigger moments at substantially constant time intervals. The clock signal may for instance be a block signal, in which the trigger moments for the memory device 20 are determined by an edge, falling or rising, of the clock signal, but these details are not essential.

According to an important aspect of the invention, the operative state of the controller 12 is determined by the contents of one of the memory elements 21(x). In other words, the switching state of the bridge 10 is dictated by the contents of said one of the memory elements 21(x). At each trigger moment in the clock signal, the operative state of the controller 12 will be based on another memory element. This is continued until all memory elements have been “used”, and then the cycle is repeated. The order in which operation runs through the memory elements is fixed; this order will be indicated as the order of the memory elements, and will be considered as a device property of the memory 20 or, more generally, of the driver 10; numbering of the memory elements will be done accordingly herein. Thus, at a trigger moment, the operative state of the controller 12 will be based on the previous memory element 21(x−1). For sake of convenience, memory elements will be indicated as successive or “neighboring” in said order, in other words memory element 21(x−1) and memory element 21(x) are mutually successive or neighboring element, which does not necessarily mean that they are physically adjacent.

In one embodiment, the operative state of the controller 12 is always determined by the contents of a fixed memory element, for instance the last memory element 21(N). At each trigger moment in the clock signal, each memory element 21(i) will take the value of its neighbor 21(i−1), while the first memory element 21(1) will take the value of the last memory element 21(N). This mode of operation is schematically illustrated in FIG. 3. If memory element 21(N−1) contained the same value as the last memory element 21(N), the operative state of the controller 12 and hence the switching state of the bridge remains the same. If memory element 21(N−1) contained a value differing from the value of the last memory element 21(N), the operative state of the controller 12 and hence the switching state of the bridge is reversed.

The order of the memory elements may be determined by fixed connections between successive elements (hardware solution). However, it is also possible that the order of the memory elements is determined by information stored in one or more further memory locations of the memory device 20. Further, it is also possible that the order of the memory elements is determined by software of the controller.

In an other embodiment, the controller 12 is provided with a pointer pointing to one of the memory elements 21(x), and the operative state of the controller 12 is always determined by the contents of the memory element 21(x) indicated by the pointer. Such pointer may be implemented as a memory element containing the address of the location of memory element 21(x). At each trigger moment in the clock signal, the pointer points to the address of the neighboring memory element 21(x−1), while after the first memory element 21(1) the pointer will point to the last memory element 21(N).

Of course, the pointer may also run through the element addresses in the opposite order, and a similar remark applies to the first embodiment.

In both cases, the switching pattern (historical development of the switching state) of the bridge is completely determined by the contents of the memory device 20 in conjunction with the order of the elements, and the pace at which the switching state of the bridge runs through this predetermined series is determined by the clock frequency. The contents of the memory device 20 in conjunction with the order of the elements are preferably selected such as to result in a quasi-random switching of the bridge. However, it is also possible to deliberately introduce a certain frequency component.

In the embodiment shown, the first output terminal 13 is coupled to the last memory element 21(N), so that its output signal corresponds to the value of the last memory element 21(N), either HIGH or LOW. The second output terminal 14 provides an output signal opposite to the output signal at first output terminal 13, i.e. LOW or HIGH, respectively. This is for instance effected by an inverting level shifter 15 coupled between the first output terminal 13 and the second output terminal 14. The first output terminal 13 and the second output terminal 14 are coupled to the respective switches M1, M2, so that the switching state of these switches corresponds to the output signals of the first output terminal 13 and the second output terminal 14.

The clock device 30 may be a fixed-frequency device. Preferably, however, the clock frequency is controllable. In a preferred embodiment, the clock device 30 is implemented as a voltage-controlled oscillator, responsive to a control voltage Vc supplied by a clock controller 40. The clock controller 40 can amend its control voltage Vc in order to correct deviations of the VCO 30. It is also possible that the clock controller 40 amends its control voltage Vc in order to control the lamp power. Since the transfer characteristic of the bridge, particularly governed by the inductive element L, depends on frequency, such that a higher frequency results in a lower lamp power, it is possible to correct deviations in lamp power such as for instance caused by aging of the lamp. Due to aging, the lamp voltage rises, and the resulting rise in lamp power can be compensated by changing the frequency. FIG. 1 shows that the driver 10 may comprise a lamp voltage sensor 16 for measuring lamp voltage, and a lamp current sensor 17 for measuring lamp current. The clock controller 40 receives from the lamp voltage sensor 16 a first measuring signal S1 representing lamp voltage, and receives from the lamp current sensor 17 a second measuring signal S2 representing lamp current. From these signals, the clock controller 40 calculates lamp power, and it amends its control voltage Vc such that the calculated lamp power remains equal to a predetermined target power value. As an alternative, it is also possible that an analogue circuit is used for approximating a corrected control voltage Vc; such solution could provide a reduction in costs.

It is noted that such amendments of the control voltage Vc take place at a relatively large time scale. It is further noted that, even with a change of clock frequency, the shape of the frequency spectrum does not change because the relative switching pattern does not change.

Summarizing, the present invention provides a driver 10 for driving a gas discharge lamp 11 comprises at least two controllable switches M1, M2 and a controller 12 for controlling the switches. The controller has a first operative state in which one switch M1 is conductive while the other switch M2 is non-conductive, and has a second operative state in which said other switch M2 is conductive while said first switch M1 is non-conductive. The controller comprises a memory device 20 comprising a plurality of memory elements 21 each containing a binary value (“0”; “1”), wherein the value of the last memory element 21(N) determines the operative state of the controller.

Responsive to a clock signal S_{CL} generated by a clock device 30, the memory device shifts the contents of each memory element 21(i) to a neighboring memory element 21(i+1) and shifts the contents of the last memory element 21(N) to the first memory element 21(1).

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, it is possible that the invention is used to effect a single frequency switching; for instance, the memory elements may contain the value 10101010 . . . , so that the bridge state is reversed at the clock frequency. It is also possible to have the memory 20 designed such that a combination of random switching and a fixed frequency component results. Further, different bridge topologies are possible.

Further, as mentioned above, the order of the memory elements is fixed during normal operation: during each cycle, operation runs through the memory elements in the same order. However, it is possible that the driver is capable of changing the order: as from the moment of the change, the “new” order is taken as the fixed order through which operation repeatedly runs. Such changes can be implemented relatively easily if the order is determined by software, or in the case of the pointer embodiment.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Driver (10) for driving a gas discharge lamp (11), the driver comprising at least two controllable switches (M1, M2) and a controller (12) for controlling the switches, the controller having a first operative state in which it generates control signals for the controllable switches such that at least a first one (M1) of said switches is conductive while at least a second one (M2) of said switches is non-conductive, and having a second operative state in which it generates control signals for the controllable switches such that said second one (M2) of said switches is conductive while said first one (M1) of said switches is non-conductive;
wherein switching of the controller from its first operative state to its second operative state determines a lamp current frequency;
wherein the controller comprises a memory device (20) comprising a plurality of memory elements (21) each containing a binary value (“0”; “1”), the memory elements (21) having a predetermined order;
wherein the operative state of the controller is always determined by the contents of one of said memory elements (21(x));
wherein the controller further comprises a clock device (30) for generating a clock signal (S_{CL}) defining regular trigger moments;
and wherein the controller, on the trigger moments, is responsive to the clock signal (S_{CL}) by defining its operative state on the basis of the contents of a subsequent memory element (21(x−1)) as determined by said order.

2. Driver according to claim 1, wherein the operative state of the controller is always determined by the contents of a fixed memory element (21(N)), and wherein the memory device (20), on the trigger moments, is responsive to the clock signal (S_{CL}) by shifting the contents of each memory element (21(i)) to a subsequent memory element (21(i+1)) and by shifting the contents of the last memory element (21(N)) to the first memory element (21(1)).

3. Driver according to claim 1, wherein the controller is provided with a pointer pointing to one of the memory elements (21(x)), and the operative state of the controller is always determined by the contents of the memory element (21(x)) indicated by the pointer; and wherein the controller, on the trigger moments, is responsive to the clock signal (S_{CL}) by making the pointer point to the address of the subsequent memory element (21(x−1)).

4. Driver according to claim 3, wherein the pointer is implemented as a memory element containing the address of the location of said one of the memory element (21(x)).

5. Driver according to claim 1, wherein the clock device (30) is a controllable clock device.

6. Driver according to claim 5, wherein the clock device (30) is implemented as a voltage-controlled oscillator.

7. Driver according to claim 5, wherein the controller further comprises a clock controller (40) for generating a clock control signal (Vc), the clock device (30) being responsive to the clock control signal by adapting its clock signal frequency on the basis of the clock control signal.

8. Driver according to claim 7, wherein the driver further comprises measuring means (16; 17) for measuring at least one lamp operation parameter, and wherein the clock controller (40) is responsive to a measuring output signal (S1; S2) from the measuring means by adapting its clock control signal.

9. Driver according to claim 8, wherein the measuring means comprise a lamp voltage sensor (16).

10. Driver according to claim 8, wherein the measuring means comprise a lamp current sensor (17).

11. Driver according to claim 8, wherein the clock controller (40) is designed to adapt its clock control signal on the basis of the measuring output signals from the measuring means such as to keep the lamp power substantially constant.

12. Driver according to claim 1, wherein said two switches (M1, M2) are arranged in series between two power supply lines, and wherein lamp output terminals for connecting the lamp are arranged in a circuit branch connected to a node between said two switches.

13. Driver according to claim 12, wherein an inductive element (L) is arranged in series with said lamp output terminals, and wherein a capacitive element (C) is arranged in parallel with said lamp output terminals.
